(19) United States
(12) Patent Application Publication
(10) Pub. No.: US 2011/0088957 A1
(43) Pub. Date: Apr. 21, 2011

(54) AXIALLY OFFSET MOTOR

(75) Inventors: EDWARD P. YANKOSKI, CORONA, CA (US); TERENCE G. WARD, REDONDO BEACH, CA (US)

(73) Assignee: GM GLOBAL TECHNOLOGY OPERATIONS, INC., DETROIT, MI (US)

(21) Appl. No.: 12/603,358

(22) Filed: Oct. 21, 2009

(51) Int. Cl. B60K 7/00

(52) U.S. Cl. 180/62

(57) ABSTRACT

A vehicle is provided. The vehicle comprises an axle having a longitudinal dimension along a first axis, the axle coupled to at least one wheel, and a motor coupled to the axle and adapted to turn the axle, the motor adapted to rotate around a second axis, wherein the motor is oriented such that the first axis is substantially perpendicular to the second axis.

### TECHNICAL FIELD

Embodiments of the subject matter described herein relate generally to electric motors for vehicles. More particularly, embodiments of the subject matter relate to positioning of axial motors for vehicles.

### BACKGROUND

Vehicles, including electric and hybrid-electric vehicles, typically use a motor to rotate an axle coupled to two wheels for locomotion. The motor is typically co-axial with the axle. Electrical power is typically used to rotate a rotor of the motor, which, in turn, rotates the axle. The turning of the axle causes the wheels to rotate, which in turn propels the vehicle in the desired direction.

A motor which is co-axial with the axle turning wheels of the vehicle has inherent limitations. For example, the outer radius of the motor is limited by the clearance of the axle above the ground. Consequently, the moment arm of the motor is limited by the outer radius of the motor, which affects the maximum torque which can be produced by the motor.

As another example, co-axial placement of the motor results in a relatively large number of driveline components, which increases the complexity of the assembly. A large number of components can be relatively more difficult to maintain and repair than a smaller number of components.

### BRIEF SUMMARY

A vehicle is provided. The vehicle comprises an axle having a longitudinal dimension along a first axis, the axle coupled to at least one wheel, and a motor coupled to the axle and adapted to turn the axle, the motor adapted to rotate around a second axis, wherein the motor is oriented such that the first axis is substantially perpendicular to the second axis.

A drive system for a vehicle is also provided. The drive system comprises an axle having a long dimension along a first axis, a motor having a rotating member adapted to rotate around a second axis, the motor oriented such that the first axis is substantially perpendicular to the second axis, and a shaft coupling the motor and the axle, the motor offset from the axle along the second axis, the shaft adapted to transmit power from the motor to the axle.

Another drive system for a vehicle is provided. The drive system comprises an axle having a longitudinal dimension along a first axis, a motor adapted to rotate around a second axis, wherein the motor is oriented such that the second axis is substantially perpendicular to the first axis, the second axis offset from the first axis, a shaft coupling the motor and the axle, the motor offset from the axle along the second axis by the shaft, the shaft adapted to transmit power from the motor to the axle, and a gear assembly coupling the shaft to the axle, the gear assembly adapted to transmit power from the shaft to the axle.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of an embodiment of a vehicle having a horizontally mounted motor;

FIG. 2 is a side view of a detailed portion of the embodiment of FIG. 1;

FIG. 3 is a perspective view of the motor assembly of FIG. 1;

FIG. 4 is a cross-sectional view of the embodiment of FIG. 3 as viewed from the line 4-4;

FIG. 5 is a cross-sectional view of another embodiment of a horizontally mounted motor assembly;

FIG. 6 is a side view of an embodiment of a vehicle having an offset motor extending in a rearward direction; and

FIG. 7 is a side view of an embodiment of a vehicle having an offset motor extending in a forward direction.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

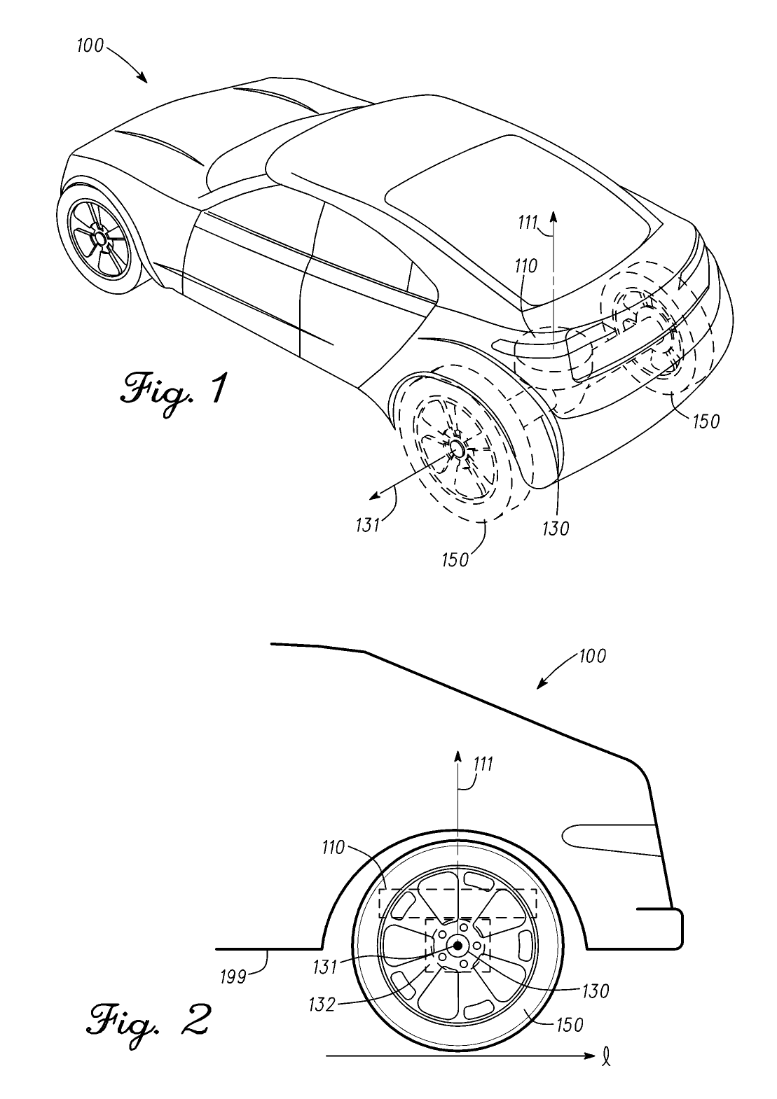

“Coupled” —The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the schematic shown in FIG. 1—depicts one exemplary arrangement of elements, additional intervening elements, devices, features, or components may be present in an embodiment of the depicted subject matter.

“Adjust” —Some elements, components, and/or features are described as being adjustable or adjusted. As used herein, unless expressly stated otherwise, “adjust” means to position, modify, alter, or dispose an element or component or portion thereof as suitable to the circumstance and embodiment. In certain cases, the element or component, or portion thereof, can remain in an unchanged position, state, and/or condition as a result of adjustment, if appropriate or desirable for the embodiment under the circumstances. In some cases, the element or component can be altered, changed, or modified to a new position, state, and/or condition as a result of adjustment, if appropriate or desired.

“Inhibit” —As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion.

As used herein, a co-axial motor means one having an axis of rotation coinciding with the axis of rotation of the axle. Thus, such a motor can be positioned on and extend radially outward from the axle. Such a co-axial motor can be located between two wheels of the vehicle, at any point along the axle, including a central position.

FIG. 1 illustrates an embodiment of a vehicle 100 having a horizontally mounted motor 110 coupled to an axle 130 supporting two wheels 150. FIG. 2 illustrates a detailed side view of a portion of the vehicle 100. The horizontally mounted motor 110 can have several advantages over a co-axial motor situated vertically along the axle 130. Because the horizontally mounted motor 110 does not extend radially outward in a direction toward the ground, the outer diameter of the motor 110 is not limited by clearance of the vehicle 100 over the ground. Accordingly, the outer diameter of a horizontally mounted motor 110 can be larger by any amount desired and/or appropriate for the embodiment. A larger diameter motor 110 can have a larger moment arm resulting in increased torque. Additionally, the increased torque can be accomplished with a lower force, resulting in weight reduction for certain components. These advantages are in addition to those described below.

The vehicle 100 of the illustrated embodiment is a hybrid-electric automobile. In other embodiments, other vehicles can be have one or more of the features described herein, including, without limitation, electric automobiles, all-terrain vehicles, trucks, and sport utility vehicles. The vehicle 100 can have one or more wheels 150 coupled together, supported by, and driven by the axle 130. The wheels 150 depicted as drive wheels are the rear wheels of the vehicle 100 in the illustrated embodiment. In other embodiments, the front wheels can be used, as desired.

The axle 130 preferably extends between the wheels 150. The axle 130 can be a solid component, or can contain one or more rotating flexible axle shafts 134 coupled to the wheels 150 as desired. The axle shaft 134 can be the component of the axle 130 which actually rotates and transmits power to the wheels 150. The axle 130 can extend to both wheels 150, as shown. In certain embodiments, the axle 130 can extend to only one wheel 150, while the other is independently suspended and/or supported. In such embodiments, the motor 110 can provide power only to the wheel coupled to the axle, while the other wheel is free to rotate.

Although the illustrated embodiment of the vehicle 100 depicts the motor 110 coupled to an axle 130 situated to the rear of the vehicle, in certain embodiments, the motor 110 can be coupled to a front axle of a vehicle. In such embodiments, the motor 110 can be adapted to transmit power through the front axle to the front wheels. Thus, any of the features described herein can be equally applicable to front wheel driven vehicles, as well as the rear wheel embodiments depicted. Therefore, an “axle” can be either a front or rear axle, depending on the desired embodiment. The motor 110 can be positioned relative to the axle 130 as described below, regardless of whether the axle is the front axle of a four vehicle or the rear axle.

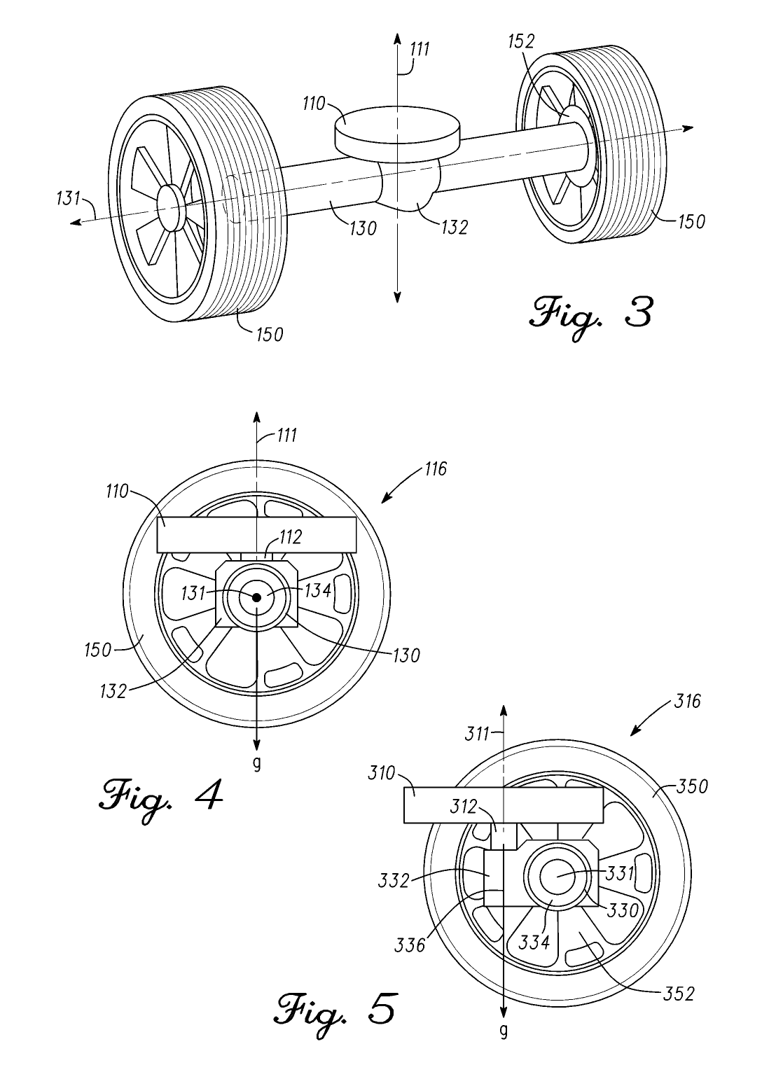

The wheels 150 can be any type of wheel appropriate to the embodiment. With additional reference to FIG. 3, a detailed perspective view of the motor assembly 116 with certain components of the vehicle 100 omitted for clarity. As can be seen, the wheels 150 can be coupled to the axle 130 with a bearing assembly 152. The wheels 150 can additionally be coupled to the axle shaft 134 to receive a rotating force therefrom. The wheel 150 can have any desired size or configuration sufficient to rotate in response to the force from the axle shaft 134, thereby propelling the vehicle 100.

The motor 110 can be coupled to the axle 130, including the axle shaft 134 in any desired manner. The motor 110 can be any motor which generates rotational force for a central shaft, including those motors having a substantially circular shape, such as in the illustrated embodiment. Such motors are commonly known as pancake motors, although other names and designations can be used. The motor 110 can be an electric motor of any desired type, including without limitation, an axial flux motor.

The motor 110 can comprise one or more components rotating about a central axis, including rotors, as well as stationary components, such as a stator. Additionally, other components, including bearing assemblies, a resolver, gear assemblies, and so on, can cooperate with or be included with the motor 110. The motor 110 can include rotors and/or stators with one or more spokes radiating from the central axis. The spokes can be composed of any appropriate material, including metals, as well as lighter-weight materials, such as carbon fiber materials.

With additional reference to FIG. 4, a cross-sectional view of the motor assembly 116 is shown. The motor 110 can couple to the axle 130 at a coupling site 132. The coupling site 132 can include one or more gears and/or gear assemblies which transmit power from the motor 110 to the axle shaft 134. A coupling site 132 can include a right angle differential to transmit rotational power from the axis of generation by the motor 110 to a drive axis of the axle shaft 134. The coupling between the motor 110 and axle shaft 134 can have any number of components, systems, or sub-assemblies necessary to perform the power transmission functions described herein. A shaft 112 can be present between the motor 110 and the coupling site 132, as visible in FIG. 4. In certain embodiments, the shaft 112 can be omitted, and the motor 110 can be coupled directly to the coupling site 132. The coupling site 132 and central motor axis 111 can be at the center of the axle 130, or offset from the center in either direction, as desired.

As shown, the circular motor 110 can have a central motor axis 111 about which its internal components rotate, and around which power is generated. Similarly, the axle 130 can have a central axle axis 131 along its long dimension. The central axle axis 131 can be substantially parallel to flat, level ground beneath the vehicle 100. In typical motor assemblies, the motor and axle share a common central axis, known as a co-axial arrangement. By contrast, the central motor axis 111 can be substantially perpendicular to the central axle axis 131, as shown. In certain embodiments, including the illustrated embodiment, the central motor axis 111 can be substantially parallel to the downward direction of gravity when the vehicle 100 is on flat, level ground. As used herein, the indicator/is used to show the level of flat, level ground, while the indicator g is used to indicate the downward direction of gravity. The vehicle 100 can have a bottom plane 199 substantially parallel to the level of flat, level ground. The bottom plane 199 can be formed by one or more components, such as a body pan. The bottom plane 199 need not be a literal plane, and instead refers to the substantially planar shape of the underside of a vehicle.

Additionally, a substantially perpendicular direction does not require that two components intersect, or that any intersection occur at exactly 90°. Rather, two directions can be substantially perpendicular if they do not intersect, but the angle formed between the two directions when projected to a plane containing either direction is about 90°. Thus, two lines which extend in directions separated by 85° can be considered substantially perpendicular. Directions which form as angles greater than 85° can be considered substantially perpendicular as well. Substantially parallel directions are similar in that they can form a small non-zero angle of approximately 5° or less while still being considered substantially parallel.

As described above, because the motor 110 is mounted along an axis of rotation substantially perpendicular to the axis of rotation of the axle shaft 134, it is not constrained in a radial outward direction of the motor 110 by the clearance of the vehicle 100 above the ground. Accordingly, the motor 110 can advantageously have a larger size. For example, where a co-axial motor in the prior art typically has an outer diameter of between 12 and 15 inches, a horizontally mounted motor, such as the motor 110 of the motor assembly 116, can have an outer diameter of 24 inches, or larger, as desired. In certain embodiments of the motor 110, the same force as a similar co-axial motor can be used to generate torque, resulting in a torque greater than that of a similar co-axial motor. In other embodiments, a force comparatively smaller than that of a similar co-axial motor can be used to generate torque which is still comparatively larger than that of a similar co-axial motor. The lower force is sufficient because of the increased outer diameter, resulting in a larger moment arm. Because a comparatively lower force is used, however, the required strength of the components of the motor 110 can be reduced. As a result, components composed of lighter-weight material can be used, while still providing the required strength. For example, one or more of the components of the motor 110 can be composed of a composite and/or ceramic material, if desired.

With reference to FIG. 5, another embodiment of a motor assembly 316 is shown. Unless otherwise mentioned, the components of FIG. 5 are substantially similar to those described above with reference to FIGS. 1-4, except that the indicators have been incremented by 200.

The central motor axis 311 can be offset from the central axle axis 331, as shown. Unlike the embodiment of FIGS. 1-4, the central motor axis 311 and central axle axis 331 do not intersect, and the central motor axis 311 does not extend through the central axle axis 331. This is because the motor 310 is offset from the center of the axle 330, as shown. Accordingly, the shaft 312 extending along the central motor axis 311 is coupled to the coupling site 332 via an extension portion 336.

The extension portion 336 can receive the shaft 312, including any rotating components transmitting power from the motor 310. The coupling site 332 can include one or more gear assemblies adapted to transmit power from the motor 310 to the axle shaft 334 through the extension portion 336 and the remainder of the coupling site 332. As with the embodiment of FIGS. 1-4, the coupling between the motor 310 and axle shaft 334 can have any number of components, systems, or sub-assemblies necessary to perform the power transmission functions described herein.

As shown, the central motor axis 311 can still be substantially parallel to the downward direction of gravity and substantially perpendicular to the central axle axis 331. The length of the shaft 312 can vary between embodiments, from being omitted entirely to any desired length.

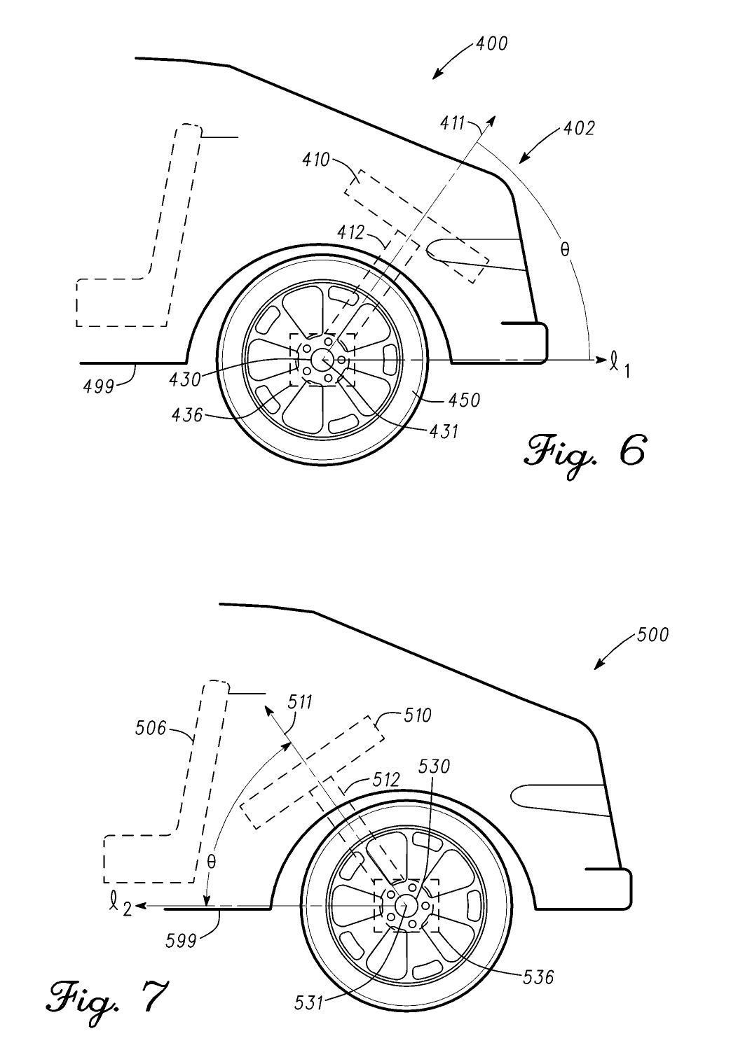

FIG. 6 illustrates another embodiment of the vehicle 400. Unless otherwise mentioned, the components of FIG. 6 are substantially similar to those described above with reference to FIGS. 1-4, except that the indicators have been incremented by 300. In the embodiment of FIG. 6, a motor 410 is coupled to an axle 430 such that the central motor axis 411 forms an acute angle with the direction of flat and level ground l₁. The angle between the central motor axis 411 and flat, level ground l₁ can be any desired angle between 0° and 90°. As a result, the shaft 412 coupling the motor 410 to the coupling site 432 can extend at an angle towards the rear 402 of the vehicle 400. Consequently, the motor 410 is positioned closer to the rear 402 of the vehicle 400 than the axle 430 is. The distance of the motor 410 from the axle 430 can be increased by increasing the length of the shaft 412. Accordingly, the position of the motor 410 can be adjusted to any desired rearward position. In certain embodiments, the motor 410 can be positioned against the rear exterior of the vehicle 400, enhancing rear performance.

Moreover, in certain embodiments, an angle can be formed between the central motor axis 411 and the central axle axis 431, if desired. Thus, the motor 410 can “lean” toward either wheel by any desired number of degrees, subject to the physical constraints of the motor 410. The coupling site 432 can include features required to redirect the rotational force to the shaft 412.

FIG. 7 illustrates another embodiment of the vehicle 500. Unless otherwise mentioned, the components of FIG. 7 are substantially similar to those described above with reference to FIGS. 1-4 and 6 except that the indicators have been incremented by 400 and 100, respectively. In the embodiment of FIG. 7, a motor 510 is coupled to an axle 530 such that the central motor axis 511 forms an acute angle with the direction of flat and level ground l₂. Unlike FIG. 6, the shaft 512 extends toward the front 504 of the vehicle 500, positioning the motor 510 closer to the front 504 of the vehicle 500 than the axle 530 is positioned. The length of the shaft 512 can be varied to any desired amount, adjusting both the distance between the motor 510 and axle 530, as well as the position within the vehicle 500 of the motor 510. In certain embodiments, the motor 510 can be positioned adjacent one or more rear seats 506 of the vehicle 500.

With reference back to FIG. 6, the position of a motor within a vehicle can be selected, either forward or rearward of the axle. The position of the motor 510 can be selected to adjust the weight characteristics of the vehicle 500. It is desirable for a vehicle to have weight evenly distributed between the front and rear wheels. By adjusting the length of the shaft 512, as well as the forward or rearward projection of the shaft 512, the weight distribution of the vehicle 500 over the wheels can be adjusted. Such adjustment of position is another advantage of an axially offset motor over a co-axial motor.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A vehicle comprising:
an axle having a longitudinal dimension along a first axis, the axle coupled to at least one wheel; and
a motor coupled to the axle and adapted to turn the axle, the motor adapted to rotate around a second axis, wherein the motor is oriented such that the first axis is substantially perpendicular to the second axis.

2. The vehicle of claim 1, wherein the motor is coupled to the axle with a gear assembly, the gear assembly adapted to transmit power from the motor to the axle.

3. The vehicle of claim 1, wherein the motor comprises an electric motor.

4. The vehicle of claim 3, wherein the motor comprises an axial flux motor.

5. The vehicle of claim 1, wherein the motor is coupled to the axle by a shaft, the shaft extending substantially perpendicular to the axle.

6. The vehicle of claim 1, wherein the motor is positioned such that the second axis is substantially perpendicular to a bottom plane of the vehicle.

7. The vehicle of claim 1, wherein the motor comprises a rotating member having a plurality of spokes extending radially outward from the second axis.

8. The vehicle of claim 7, wherein at least one of the plurality of spokes is composed of carbon fiber material.

9. A drive system for a vehicle, the drive system comprising:
an axle having a long dimension along a first axis;
a motor having a rotating member adapted to rotate around a second axis, the motor oriented such that the first axis is substantially perpendicular to the second axis; and
a shaft coupling the motor and the axle, the motor offset from the axle along the second axis, the shaft adapted to transmit power from the motor to the axle.

10. The drive system of claim 9, wherein the vehicle has a front and the motor is positioned closer toward the front of the vehicle than the axle.

11. The drive system of claim 10, wherein the second axis extends away from the axle in a first direction, the first direction forming an angle of less than ninety degrees with a body plane of the vehicle.

12. The drive system of claim 10, wherein the vehicle further comprises a rear seat and the motor is disposed adjacent the rear seat.

13. The drive system of claim 9, wherein the vehicle has a rear and the motor is positioned closer toward the rear of the vehicle than the axle.

14. The drive system of claim 9, wherein the axle is a rear axle of the vehicle.

15. A drive system for a vehicle, the drive system comprising:
an axle having a longitudinal dimension along a first axis;
a motor adapted to rotate around a second axis, wherein the motor is oriented such that the second axis is substantially perpendicular to the first axis, the second axis offset from the first axis;
a shaft coupling the motor and the axle, the motor offset from the axle along the second axis by the shaft, the shaft adapted to transmit power from the motor to the axle; and
a gear assembly coupling the shaft to the axle, the gear assembly adapted to transmit power from the shaft to the axle.

16. The drive system of claim 15, wherein the axle is a front axle of the vehicle.

17. The drive system of claim 15, wherein the motor comprises a rotating member having a plurality of spokes, and at least one of the plurality of spokes is composed of a carbon fiber material.

18. The drive system of claim 15, wherein the second axis is substantially perpendicular to a bottom plane of the vehicle.

19. The drive system of claim 15, wherein the second axis extends away from the axle in a first direction, the first direction forming an angle of less than ninety degrees with a body plane of the vehicle.

20. The drive system of claim 19, wherein the vehicle has a front and the first direction extends toward the front of the vehicle.
